(19) United States
(12) Patent Application Publication
(10) Pub. No.: US 2014/0089733 A1
(43) Pub. Date: Mar. 27, 2014

(54) FILE RECORDING APPARATUS, FILE SYSTEM MANAGEMENT METHOD, FILE RECOVERY METHOD, AND CHANGER DRIVE

(71) Applicant: Sony Corporation, Tokyo (JP)

(72) Inventor: Takahiro Araki, Kanagawa (JP)

(73) Assignee: Sony Corporation, Tokyo (JP)

(21) Appl. No.: 14/032,282

(22) Filed: Sep. 20, 2013

(30) Foreign Application Priority Data
Sep. 27, 2012 (JP) 2012-214845

(51) Int. Cl. G06F 11/14

(52) U.S. Cl. CPC G06F 11/1412
USPC 714/15

(57) ABSTRACT

A file recording apparatus includes a drive and a control unit. The drive is configured to use, as a removable recording medium, a cartridge on which a non-volatile memory is mounted and in which one of a disk-shaped recording medium and a tape-shaped recording medium is stored. The control unit is configured to handle the drive as a storage device, and the control unit records a file unique number of a file in which a read error is caused in the non-volatile memory.

### CROSS REFERENCE TO RELATED APPLICATIONS

This application claims the benefit of priority under 35 U.S.C. §119 from Japanese Priority Patent Application JP 2012-214845 filed Sep. 27, 2012, the entire contents of each which is incorporated herein by reference.

### BACKGROUND

The present disclosure relates to a file recording apparatus, a file system management method, a file recovery method, and a changer drive, and more specifically to a file recording apparatus that handles, as a storage device, a drive chat uses a cartridge in which a disk-shaped or tape-shaped recording medium is stored as a removable recording medium, and the like.

In related art, for example, a file recording apparatus that handles, as a storage device, a drive that uses an optical disk cartridge as a removable recording medium is known. In a file recording apparatus of this type, a read error may occur due to an error on a block basis which is difficult to be corrected on a storage device side. For a file from which data is difficult to be read, a saving method therefor, a detection of the file, and a specification method for a recovery system are problems.

As the saving method, (1) using a file format in which an error correction code such as a parity can be embedded, (2) recording an error correction code or entire data of a main body file in the same removable medium as a different file and performing recovery by using the error correction code when data corruption is caused, and the like are conceivable. However, in the method (1), the file format, is limited, and a degree of freedom for the file format recorded by a user is restricted. In addition, in the method (2), extra files are created, so complication is increased to manage those by a user or a system.

Further, as the detection of a file from which data is difficult to be read and the specification method for recovery, (a) a method of remembering a file in which an error occurs by a user, (b) a method of recording the file in a host PC, (c) a method of recording the file in file metadata, information of the removable medium, and the like are conceivable. In the method (a), such an operation mistake that a user incorrectly specifies a corrupted file may occur. In the method (b), it is difficult to recover a corrupted file by a PC different from a PC that detects the corrupted file. In the method (c), it is difficult to carry out the method in the case where a removable medium is subjected to a recording inhibition setting.

For example, Japanese Patent Application Laid-open No. 2009-289319 discloses that an error correction process is performed by a parity from an optical disk, and when the error correction is performed, a user is urged to perform a copying process for the optical disk. Further, for example, Japanese Parent Application Laid-open No. 2008-305510 discloses that, in addition to ECC at a physical level of an optical disk, a zone for recording a higher order parity is additionally provided in the same disk and used, thereby increasing error resistance.

### SUMMARY

In view of the abovementioned circumstances, it is desirable to make it possible to detect a file from which data is difficult to be read and recover the file desirably.

According to an embodiment of the present technology, there is provided a file recording apparatus including a drive and a control unit. The drive is configured to use, as a removable recording medium, a cartridge on which a non-volatile memory is mounted and in which one of a disk-shaped recording medium and a tape-shaped recording medium is stored. The control unit is configured to handle the drive as a storage device. The control unit records a file unique number of a file in which a read error is caused in the non-volatile memory.

In the embodiment of the present technology, the drive that uses as the removable recording medium the cartridge in which the disk-shaped or tape-shaped recording medium is stored is handled as the storage device. In the cartridge, the non-volatile memory is mounted. The control unit records the file unique number of the file in which the read error is caused in the non-volatile memory.

As described above, in the embodiment of the present technology, in the non-volatile memory mounted on the cartridge, the file unique number of the file in which the read error is caused is recorded. Therefore, by referring to the file unique number recorded in the non-volatile memory, it is possible to present the file which has to be recovered to a user, which makes detection of a file to be recovered and simplification of an operation for recovery instruction by the user possible.

It should be noted that in the embodiment of the present technology, for example, the control unit may display a file recovery candidate by using the file unique number recorded in the non-volatile memory and recover a file selected. In this case, it is possible to perform recovery on a file basis and widely accept the capacity of a storage of a save destination for the file recovered and a kind thereof.

For example, the control unit may record, as a named stream of a record file, an error correction code in parallel with a main body file and recover a file by correcting an error on a block basis, which is incapable of being corrected on the storage device side, on the basis of the error correction code. In this case, when the error correction code is recorded, needless seek is not caused, and high-speed recording can be performed.

In this case, for example, metadata of the error correction code, for example, metadata such as a code length and a coding rate of parity may be held with a stream name of the named stream. In this case, it is possible to manage the metadata of the error correction code at the same storage level as the metadata of the main body file.

According to another embodiment of the present technology, there is provided a file recording apparatus including a drive and a control unit. The drive is configured to use, as a removable recording medium, a cartridge in which one of a disk-shaped recording medium and a tape-shaped recording medium is stored. The control unit is configured to handle the drive as a storage device. The control unit records, as a named stream of a record file, an error correction code in parallel with a main body file and recovering a file by correcting an error on a block basis, which is incapable of being corrected on the storage device side, on the basis of the error correction code.

In the embodiment of the present technology, the drive that uses as the removable recording medium the cartridge in which the disk-shaped or tape-shaped recording medium is stored is handled as the storage device. The control unit records the error correction code as the named stream of the record file in parallel with the main body file. For example, with the stream name of the named stream, the metadata of the error correction code, for example, the metadata such as the code length and the coding rate of the parity.

As described above, in the embodiment of the present technology, the error correction code is recorded as the named stream of the record file in parallel with the main body file. Therefore, when the error correction code is recorded, needless seek is not caused, high-speed recording can be performed. Further, it is possible to perform recovery on a file basis and widely accept the capacity of a storage, of a save destination for the file recovered and a kind thereof. Furthermore, in the embodiment of the present technology, the metadata of the error correction code is held with the stream name of the named stream. Therefore, the metadata of the error correction code can be managed at the same storage level as the metadata of the main body file.

It should be noted that in the embodiment of the present technology, the control unit may display the file in which the read error is caused as the recovery candidate, file and recover the file selected. In this case, it is possible for the user to easily detect the file which has to be recovered and perform an operation for recovery instruction.

For example, in this case, the non-volatile memory is mounted on the cartridge. The control unit may record a file unique number of the file in which the read error is caused, display the recovery candidate file, and recover the selected file on the basis of the file unique number recorded in the non-volatile memory.

According to the present technology, it is possible to desirably detect a file from which data is difficult to be read and recover the file.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a structural example of a file recording apparatus as an embodiment;

FIG. 2 is a diagram showing an outline of a recording process for an optical disk when new creation of a file is requested;

FIG. 3 is a diagram showing a state of FS metadata information reflection;

FIG. 4 is a diagram showing an example of file data arrangement of the file new creation (with parity);

FIG. 5 is a diagram showing an example of a UDF (universal disk format) file structure of a file (with parity);

FIG. 6 is a flowchart showing an example of a process of a file system driver in the case where a request is issued;

FIG. 7 is a diagram showing an example of a GUI screen for a file recovery; and

FIG. 8 is a diagram showing an operation principle of the file recovery.

### DETAILED DESCRIPTION OF EMBODIMENTS

Hereinafter, an embodiment of the present disclosure will be described with reference to the drawings. It should be noted that the description will be given in the following order.

1. Embodiment

2. Modified example

1. <Embodiment>

(Structural Example of File Recording Apparatus)

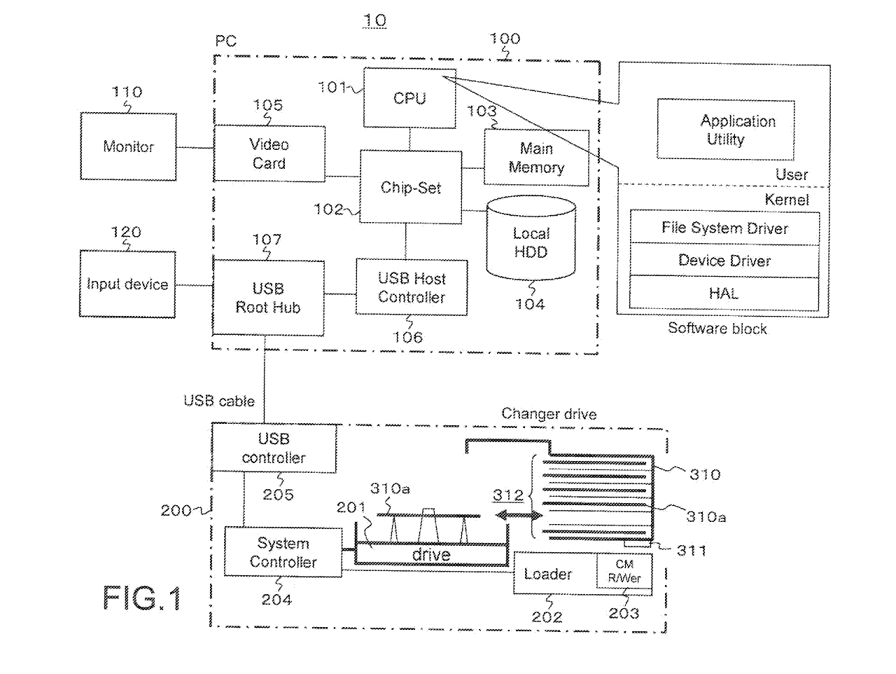

FIG. 1 is a diagram showing a structural example of a file recording apparatus 10 as an embodiment. The file recording apparatus 10 has a structure in which a changer drive 200 is connected to a personal computer (PC) 100 via a USB cable. The PC 100 handles the changer drive 200 as a storage device.

The PC 100 includes a CPU 101, a chipset 102, a main memory 103, a local HDD 104, a video card 105, a USB host controller 106, and a USB root hub 107. As user interfaces, a monitor 110 and an input device 120 such as a mouse and a keyboard are connected to the PC 100.

In the CPU 101, as software operated on the CPU 101, a file system driver, a device driver, an HAL (hardware abstraction layer), and the like are provided in addition to various applications and utilities. The HAL provides a physical I/O of a device as a standardized interface. The device driver provides a standardized interface to the changer drive connected through a USB. The file system driver provides a standardized file system interface such as a directory structure and a file.

The changer drive 200 includes an optical disk drive 201, a loader 202, a cartridge memory (CM) reader and writer (R/Wer) 203, a system controller 204, and a USB controller 205. The changer drive 200 uses a cartridge 310 in which a predetermined number of optical disks 310a are stored as a removable recording medium. On the cartridge 310, a cartridge memory (CM) 311 which is capable of performing proximity communication and has a non-volatile memory therein is mounted.

The changer drive 200 is controlled by a USB command from the PC 100 as a USB mass storage class. On the basis of the command from the PC 100, the loader 202 loads the optical disk 310a of any slot 312. in the cartridge 310 into the optical disk drive 201 or unloads (ejects) the optical disk 310a to store the disk in an original slot 312 of the cartridge 310.

The optical disk drive 201 forms an optical disk recording and reproduction unit. The optical disk drive 201 performs recording and reproduction for the optical disk 310a loaded. The CM reader and writer 203 performs recording and reproduction for the cartridge memory 311 by the proximity communication. The CM reader and writer 203 forms a memory recording and reproduction unit.

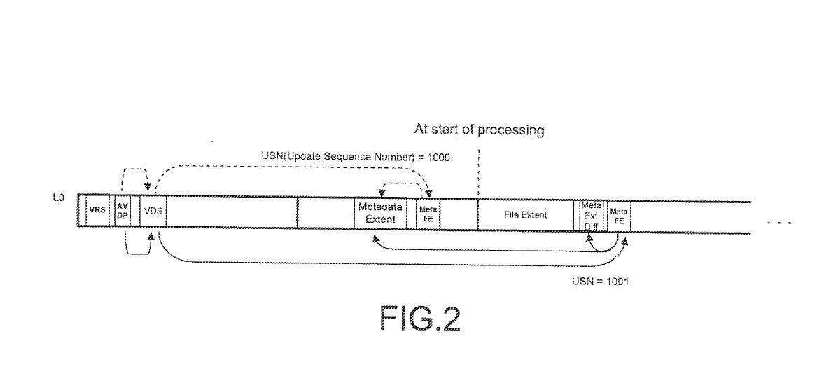

FIG. 2 is a diagram showing an outline of a recording process in an optical disk when new creation of a file is requested. A “Metadata Extent” is a region in which file directory information is stored. A “Metadata FE” is region information (address and size) of the “Metadata Extent”. A “VDS” is region information (address and size) of the “Metadata FE”. An “AVDP” is pointer information (address and size) to the “VDS”. It should be noted that in this example, “UDF2.50” is based, and other “AVDP”, “RVDS”, “Metadata Mirror FE” redundantly recorded are omitted in the figure for convenience of explanation.

Broken-line arrows indicate region information for which UDF (universal disk format) descriptors each perform indication with a pointer before a process is started (USN=1000). In addition, solid-line arrows indicate region information for which UDF descriptors each perform indication with a pointer after the file system driver reflects changed information on FS metadata information of the optical disk 310a during mounting in a process in response to a change request (USN=1001). In this case, the “VDS” is overwritten by new information.

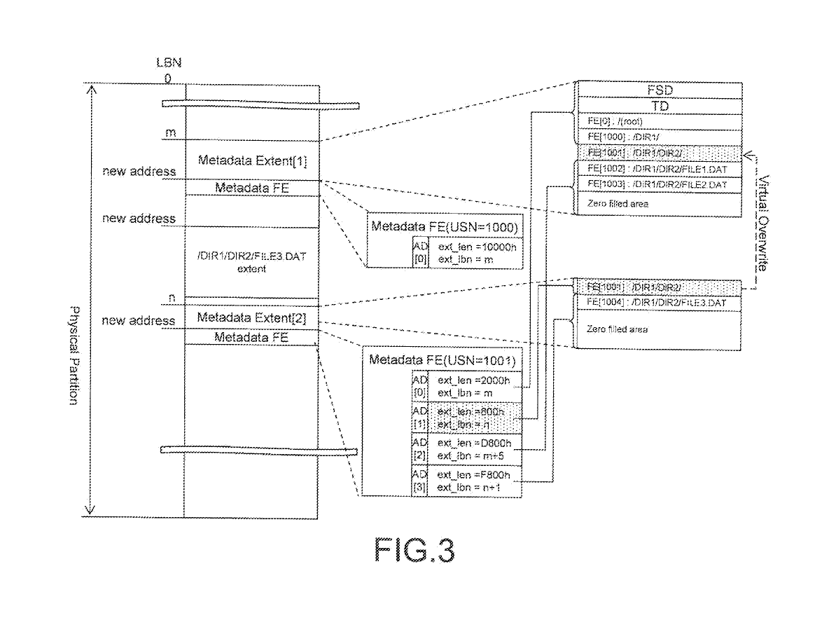

FIG. 3 is a diagram showing a state of reflection of the FS metadata information. Here, by new creation of a file, the file system is updated from “USN=1000” to “USN=1001”.

In “Metadata Extent[1]”, the following information is recorded.

```
/(root) [symbol]
  DIR1/ [symbol]
    DIR2/ [symbol]
      FILE1.DAT [symbol]
      FILE2.DAT
```

It should be noted that in an actual UDF, a pointer from an FE of a parent directory to FID information is held, and as the FID information, a pointer to a child file directory and name information are stored, but the FID is omitted in the figure. Further, FE[1000] represents an FE of “FUID (File Unique ID)=1000”. An equivalence of the “File Unique ID” is recorded in a “Unique ID” in the FE.

In the example shown in the figure, as file new creation, “/DIR1/DIR2/FILE3.DAT” is added. In “Metadata Extent[2]”, an FE (including FID information) of “/DIR1/DIR2/” directory changed and the FE of “/DIR1/DIR2/FILE3,DAT” file are recorded. The region information of the “Metadata FE” is rewritten, thereby overwriting the FE of “/DIR1/DIR2/” recorded in the “Metadata Extent [1]” and adding “/DIR1/DIR2/FILE3.DAT”. In addition, a USN, which is an update identification number of the file system (FS) is recorded in the “Metadata FE” (check point information).

In the case where a new file is created in the optical disk 310a, the file system driver records a parity as an error correction code in parallel with a main body file. In this case, the file system driver records the parity as a named stream of a record file, and metadata such as a coding rate of the parity and a code length thereof is held by the stream name.

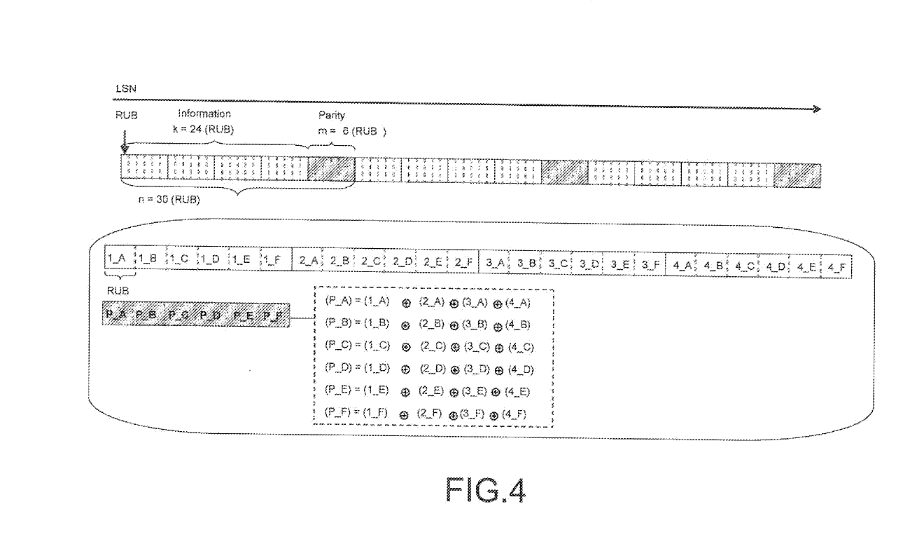

FIG. 4 is a diagram showing an example of a file data arrangement of the file new creation (with parity). In this example, the case of a code length n=30 (RUB), a reference data length k=24 (RUB), and a reference parity length m=6 (RUB) is shown. It should be noted that this example is used for explanation, and in actuality, for example, n=2064 (RUB), k=2048 (RUB), m=16 (RUB), and the like are given. In this embodiment, the optical disk 310a serving as a recording medium of the changer drive 200 is a Blu-ray disk. The “RUB” represents an access unit (recording and reproduction unit) to the optical disk 310a, and for example, the size thereof is 65,536 (64 K) bytes.

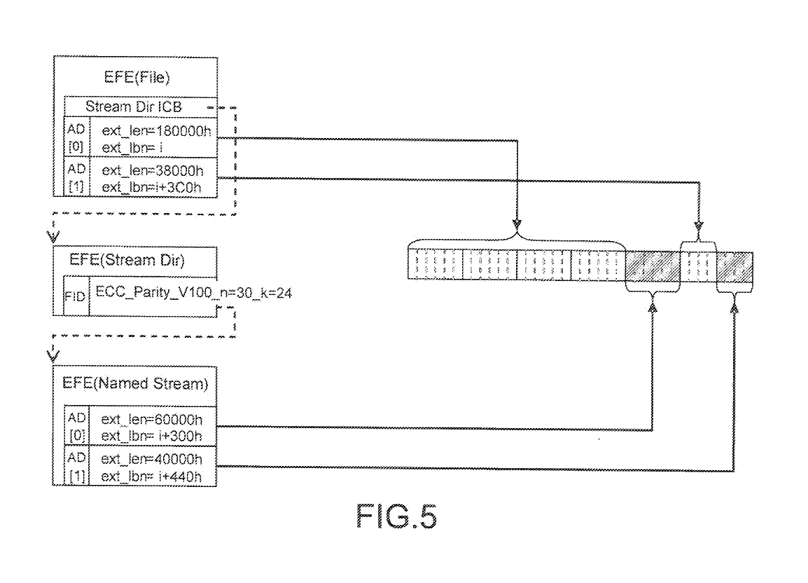

FIG. 5 is a diagram showing an example of a UDF (universal disk format) file structure of a file (with parity). The figure shows that a parity stream is recorded as a named stream of a record file. With the stream name of the named stream, (a) ECC system, (b) version information, and (c) n (code length), k (reference data length) are held. A stream name “ECC_Parity_V100_N=30_K=24” in the example shown in the figure indicates that (a) the ECC is a parity method, (b) the version is 1.00, and (c) the code length n=30 (RUB), the reference data length k=24 (RUB), and the reference parity length m=6 (RUB) are established.

As described, above, by managing the parity stream by using the named steam of the record file (parent file), the following advantages are obtained. That is, (1) when the parent file is deleted, the parity stream is also deleted at the same time, so the region management can be easily performed.

(2) By holding the metadata such as the code length and the coding rate of the parity as the named stream name, it is possible to manage the data at the same storage level as the metadata of the parent file. That is, if the metadata of the parent file can be obtained, the metadata of the parity stream can probably be obtained. Conversely, if the metadata of the parent file is erased, to obtain only the metadata of the parity stream is meaningless, but there is little possibility thereof.

In this embodiment, the file system driver records a file unique number (UID) of a file in which a read error is caused in the cartridge memory 311. In this way, the file in which the read error is caused is a recovery candidate file in a utility for file recovery to be described later.

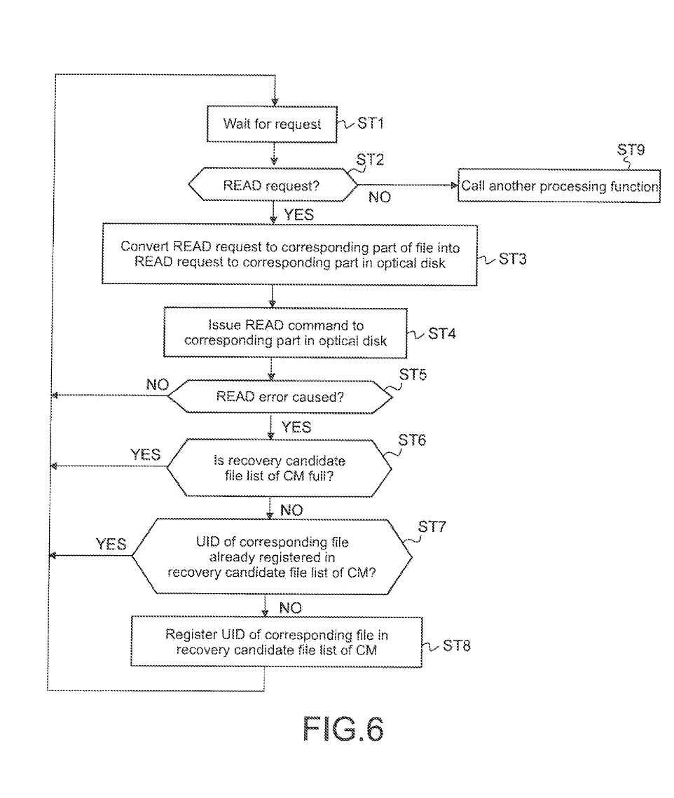

FIG. 6 is a flowchart showing an example of a process of the file system driver in the case where a request is issued. In Step ST1, the file system driver waits for the request. When the request is issued, the file system driver then performs a process of Step ST2.

In Step ST2, the file system driver determines whether the request is a READ request or not. When the request is the READ request, in Step ST3, the file system driver converts the READ request to a corresponding part of the file into a READ request to a corresponding part of the optical disk 310a.

Then, in Step ST4, the file system driver issues a READ command to the changer drive 200 for a corresponding part of the optical disk 310a. As a result, in the changer drive 200, reading of the corresponding part of the file is started.

Then, in Step ST5, the file system driver determines whether a READ error is generated in the changer drive 200 or not. If the READ error is generated, in Step ST6, the file system driver determines whether a recovery candidate file list of the cartridge memory (CM) 311 is in a fill state or not.

When the recovery candidate file list is not in the fill state, the file system driver then performs a process of Step ST7. In Step ST7, the file system driver determines whether the unique number of the file, that is, the UID (Unique ID) has already been registered in the recovery candidate file list or not.

In the case where the registration has not been carried out, in Step ST8, the file system driver registers the UID of the file in the recovery file list of the cartridge memory 311. After Step ST8, the file system driver performs Step ST1 again and is brought into the request standby state.

It should be noted that, when the READ error is not caused in Step ST5, the recovery candidate file list is in the full state in Step ST6, or the UID of the file has already been registered in the recovery candidate list in Step ST7, the process immediately returns to Step ST1, and the file system driver is brought into the request standby state. Further, in the case where the request is not the READ request, the process proceeds to Step ST9, and the file system driver calls another processing function corresponding to the request and performs the processing.

In this embodiment, in the utility for the file recovery, the file recovery can be performed. In the case where the file recovery is instructed by a user operation, on the basis of the UID registered in the recovery candidate file list of the cartridge memory 311, the utility displays a GUI screen for the file recovery on the monitor 110. When the recovery candidate file is displayed, the utility reads the recovery candidate file list (UID list) from the cartridge memory 311. At this time, the utility inquires of the file system driver as to a file pass corresponding to the UID of the file.

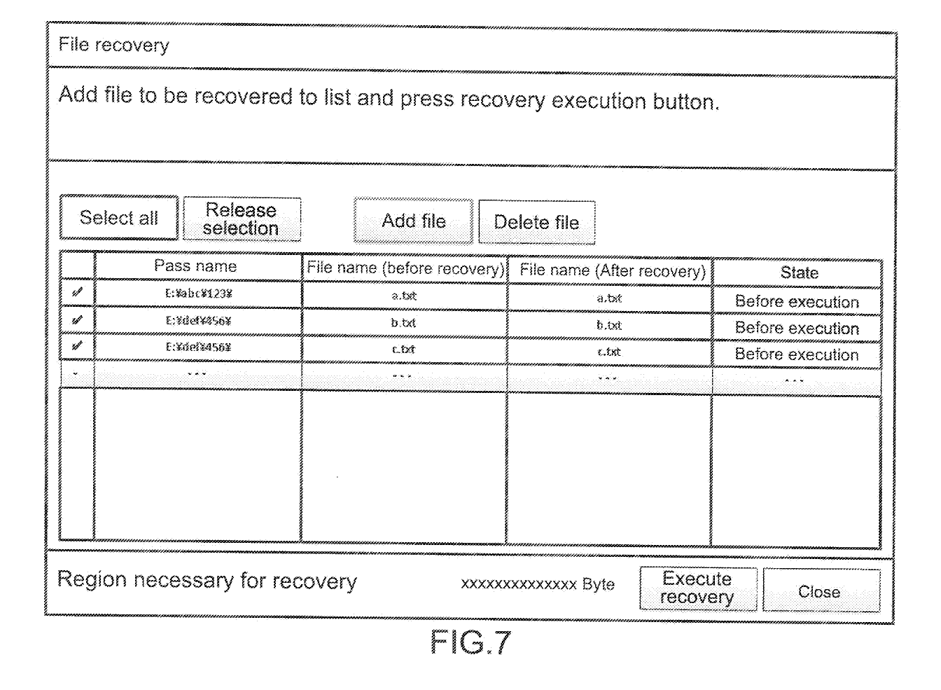

FIG. 7 is a diagram showing an example of the GUI screen. On the GUI screen, the recovery candidate file is displayed. Further, file names (before recovery), file names (after recovery), pass names, and the like are indicated so as to correspond to the files. It should be noted that, on the GUI screen, a user can add or delete a file. The user can select a file which the user wants to recover on the GUI screen as a recovery file by ticking a box thereof, for example.

In the state in which, the recovery file is selected, when a “recovery execution” button is operated, the utility performs the recovery process for the recovery file. In this case, the utility reads a main body file and a parity stream of the corresponding file from the optical disk 310a and performs the recovery process by using the parity. Then, the utility stores a file after the recovery (save file) in the local HDD 104. When the utility is successful in recovering the file, the utility deletes (clears) the UID of the corresponding file from the cartridge memory 311.

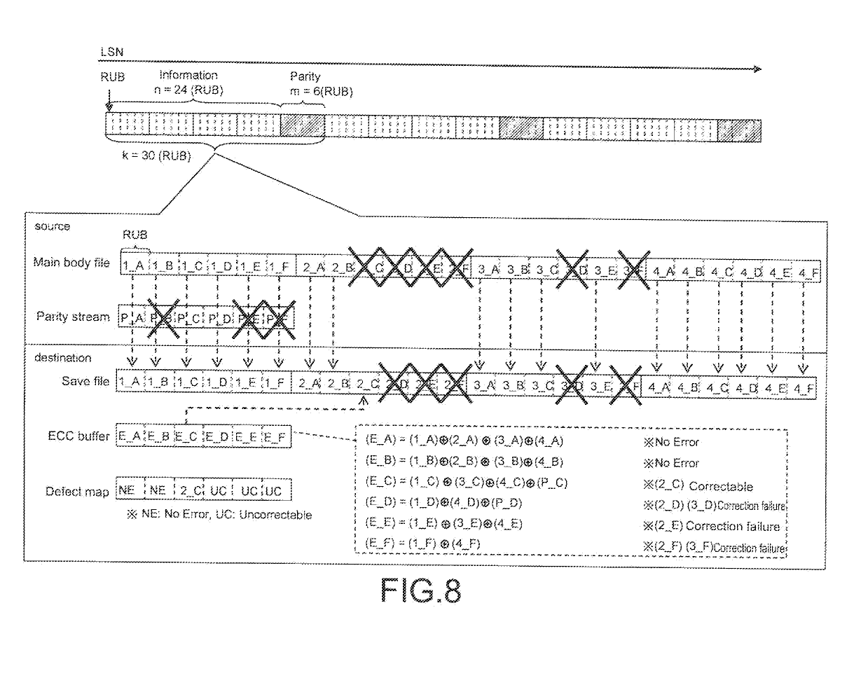

FIG. 8 is a diagram showing an operation principle of the file recovery. In an ECC buffer, an operation result by using the parity is stored. In the case where a correction can be performed, correction data is obtained. In a defect map, whether the correction can be performed or not is registered.

As described above, in the file recording apparatus shown in FIG. 1, the file system driver records the file unique number (UID) of the file in which the read error is caused, in the cartridge memory 311 mounted on the cartridge 310. Therefore, by referring to the file unique number recorded in the cartridge memory 311, a file to be recovered can be presented to the user, and the detection of the file to be recovered by the user and the simplification of the operation can be performed.

In addition, in the file recording apparatus 10 shown in FIG. 1, the utility displays the file recovery candidate with the file unique number (UID) recorded in the cartridge memory 311 and recovers the file selected. In this case, an error on a block basis which is difficult to be corrected on the storage device side is corrected on the basis of the parity, and the file recovery is performed. Thus, the recovery can be performed on a file basis, and the capacity of a storage of a save destination for the file recovered and a kind thereof are widely acceptable.

In addition, in the file recording apparatus 10 shown in FIG. 1, the file system driver records the parity (error correction code) as the named stream of the record file in parallel with the main body file. Therefore, at the time when the error correction code is recorded, needless seek is not caused, high-speed recording can be performed.

In addition, in the file recording apparatus 10 shown in FIG. 1, the metadata of the error correction code, for example, the metadata such as the code length and the coding rate of the parity is held with the stream name of the named stream. Therefore, the metadata of the parity (error correction code) can be managed at the same storage level as the metadata of the main body file.

<2. Modified Example>

It should be noted that in the above embodiment, the file unique number (UID) of the file in which the read error is caused is recorded in the cartridge memory 311 mounted on the cartridge 310. In addition to this, a position in the file where the read error is caused may be stored. From the record content of the cartridge memory 311, it is possible to easily recognize not only the file in which the read error is generated but also the error generation position in the file.

In addition, in the above embodiment, the changer drive 200 having the cartridge 310 that stores the plurality of optical disks 310a therein as the storage medium is described. However, the cartridge 310 does not necessarily store the plurality of optical disks 310a therein. Further, in the above embodiment, the file recording apparatus 10 configured by connecting the PC 100 with the changer drive 200 with the USB cable is described. The structure in which the changer drive 200 is integrally disposed in the PC 100 is also conceived, for example.

Further, in the above embodiment, the changer drive 200 uses, as the removable recording medium, the cartridge 310 in which the disk-shaped recording media (optical disks) are stored. However, even in the case where the changer drive 200 uses a cartridge in which tape-shaped recording media are stored, it is of course possible to apply the present technology thereto.

It should be noted that the present disclosure can take the following configurations.

(1) A file recording apparatus, including;

a drive configured to use, as a removable recording medium, a cartridge on which a non-volatile memory is mounted and in which one of a disk-shaped recording medium and a tape-shaped recording medium is stored; and

a control unit configured to handle the drive as a storage device, the control unit recording a file unique number of a file in which a read error is caused in the non-volatile memory.

(2) The file recording apparatus according to Item (1), in which

the control unit displays a file recovery candidate by using the file unique number recorded in the non-volatile memory and recovers a file selected.

(3) The file recording apparatus according to Item (2), in which

the control unit records, as a named stream of a record file, an error correction code in parallel with a main body file and recovers a file by correcting an error on a block basis, which is incapable of being corrected on the storage device side, on the basis of the error correction code.

(4) The file recording apparatus according to Item (3), in which

metadata of the error correction code is held with a stream name of the named stream.

(5) A file system management method in a file recording apparatus in which a drive that uses, as a removable recording medium, a cartridge on which a non-volatile memory is mounted and in which one of a disk-shaped recording medium and a tape-shaped recording medium is stored is handled as a storage device, the file system management method including

recording a file unique number of a file in which a read error is caused in the non-volatile memory.

(6) A file recording apparatus, including:

a drive configured to use, as a removable recording medium, a cartridge in which one of a disk-shaped recording medium and a tape-shaped recording medium is stored; and

a control unit configured to handle the drive as a storage device, the control unit recording, as a named stream of a record file, an error correction code in parallel with a main body file and recovering a file by correcting an error on a block basis, which is incapable of being corrected on the storage device side, on the basis of the error correction code.

(7) The file recording apparatus according to Item (6), in which

metadata of the error correction code is held with a stream name of the named stream.

(8) The file recording apparatus according to Item (6) or (7), in which

the control unit displays a file in which an read error is caused as a recovery candidate file and recovers a file selected.

(9) The file recording apparatus according to Item (8), in which

the cartridge has a non-volatile memory mounted thereon, and

the control unit records a file unique number of the file in which the read error is caused, in the non-volatile memory, displays the recovery candidate file, and recovers the selected file on the basis of the file unique number recorded in the non-volatile memory.

(10) A file recovery method in a file recording apparatus in which a drive that uses, as a removable recording medium, a cartridge in which one of a disk-shaped recording medium and a tape-shaped recording medium is stored is handled as a storage device, the file recovery method including

recording, as a named stream of a record file, an error correction code in parallel with a main body file and recovering a file by correcting an error on a block basis, which is incapable of being corrected on the storage device side, on the basis of the error correction code.

(11) A file recording apparatus, including:

a changer drive configured to use, as a removable recording medium, a cartridge on which a non-volatile memory is mounted and in which one of a disk-shaped recording medium and a tape-shaped recording medium is stored; and

a computer configured to handle the changer drive as a storage device, the computer recording a file unique number of a file in which a read error is caused in the non-volatile memory, displaying a recovery candidate file, and recovering a selected file on the basis of the file unique number recorded in the non-volatile memory.

(12) A changer drive, including:

a recording medium recording and reproduction unit configured to load, into a drive, a recording medium from a cartridge on which a non-volatile memory is mounted and in which one of a disk-shaped recording medium and a tape-shaped recording medium is stored and perform recording and reproduction with respect to the recording medium;

a memory recording and reproduction unit configured to perform recording and reproduction with respect to the non-volatile memory, the memory recording and reproduction unit recording a, file unique number of a file in which a read error is caused in the non-volatile memory; and

a control unit configured to control the recording and reproduction with respect to the recording medium and the recording and reproduction with respect to the memory.

It should be understood by those skilled in the art that various modifications, combinations, sub-combinations and alterations may occur depending on design requirements and other factors insofar as they are within the scope of the appended claims or the equivalents thereof.

What is claimed is:

1. A file recording apparatus, comprising:
a drive configured to use, as a removable recording medium, a cartridge on which a non-volatile memory is mounted and in which one of a disk-shaped recording medium and a tape-shaped recording medium is stored; and
a control unit configured to handle the drive as a storage device, the control unit recording a file unique number of a file in which a read error is caused in the non-volatile memory.

2. The file recording apparatus according to claim 1, wherein
the control unit displays a file recovery candidate by using the file unique number recorded in the non-volatile memory and recovers a file selected.

3. The file recording apparatus according to claim 2, wherein
the control unit records, as a named stream of a record file, an error correction code in parallel with a main body file and recovers a file by correcting an error on a block basis, which is incapable of being corrected on the storage device side, on the basis of the error correction code.

4. The file recording apparatus according to claim 3, wherein
metadata of the error correction code is held with a stream name of the named stream.

5. A file system management method in a file recording apparatus in which a drive that uses, as a removable recording medium, a cartridge on which a non-volatile memory is mounted and in which one of a disk-shaped recording medium and a tape-shaped recording medium is stored is handled as a storage device, the file system management method comprising
recording a file unique number of a file in which a read error is caused in the non-volatile memory.

6. A file recording apparatus, comprising:
a drive configured to use, as a removable recording medium, a cartridge in which one of a disk-shaped recording medium and a tape-shaped recording medium is stored; and
a control unit configured to handle the drive as a storage device, the control unit, recording, as a named stream of a record file, an error correction code in parallel with a main body file and recovering a file by correcting an error on a block basis, which is incapable of being corrected on the storage device side, on the basis of the error correction code.

7. The file recording apparatus according to claim 6, wherein
metadata of the error correction code is held with a stream name of the named stream.

8. The file recording apparatus according to claim 6, wherein
the control unit displays a file in which an read error is caused as a recovery candidate file and recovers a file selected.

9. The file recording apparatus according to claim 8, wherein
the cartridge has a non-volatile memory mounted thereon, and
the control unit records a file unique number of the file in which the read error is caused in the non-volatile memory, displays the recovery candidate file, and recovers the selected file on the basis of the file unique number recorded in the non-volatile memory.

10. A file recovery method in a file recording apparatus in which a drive that uses, as a removable recording medium, a cartridge in which one of a disk-shaped recording medium and a tape-shaped recording medium is stored is handled as a storage device, the file recovery method comprising
recording, as a named stream of a record file, an error correction code in parallel with a main body file and recovering a file by correcting an error on a block basis, which is incapable of being corrected on the storage device side, on the basis of the error correction code.

11. A file recording apparatus, comprising;
a changer drive configured to use, as a removable recording medium, a cartridge on which a non-volatile memory is mounted and in which one of a disk-shaped recording medium and a tape-shaped recording medium is stored; and
a computer configured to handle the changer drive as a storage device, the computer recording a file unique number of a file in which a read error is caused in the non-volatile memory, displaying a recovery candidate file, and recovering a selected file on the basis of the file unique number recorded in the non-volatile memory.

12. A changer drive, comprising;
a recording medium recording and reproduction unit configured to load, into a drive, a recording medium from a cartridge on which a non-volatile memory is mounted and in which one of a disk-shaped recording medium and a tape-shaped recording medium is stored and perform recording and reproduction with respect to the recording medium;
a memory recording and reproduction unit configured to perform recording and reproduction, with respect to the non-volatile memory, the memory recording and reproduction unit recording a file unique number of a file in which a read error is caused in the non-volatile memory; and
a control unit configured to control the recording and reproduction with respect to the recording medium and the recording and reproduction with respect to the memory.
